(19) United States
(12) Patent Application Publication
(10) Pub. No.: US 2011/0066883 A1
(43) Pub. Date: Mar. 17, 2011

(54) DATA STORAGE APPARATUS AND DATA WRITING/READING METHOD

(76) Inventor: Kenshi DACHIKU, Kawasaki-shi (JP)

(21) Appl. No.: 12/847,382

(22) Filed: Jul. 30, 2010

(30) Foreign Application Priority Data
Sep. 14, 2009 (JP) 2009-212188

(51) Int. Cl. G06F 11/14; G06F 11/10; G06F 11/00

(52) U.S. Cl. 714/6.24; 714/E11.032; 714/E11.118

(57) ABSTRACT

According to one embodiment, a data storage apparatus includes a RAID controller, error detectors, and memory units. The RAID controller receives an encoded data stream, divides the encoded data stream into a predetermined number of data blocks and generates a block of parity data. The data blocks and the parity data block are distributed to the error detectors. The error detectors add an error detection code to the data blocks and the parity data block, respectively. The memory units receive the data blocks and the parity data block from the error detectors and set the data blocks and the parity data block to have the writable page units, respectively. Each of the memory units includes a plurality of memory chips and a memory controller. The memory controllers write the data blocks and the parity data block of the writable page units in the memory chips.

### CROSS-REFERENCE TO RELATED APPLICATIONS

This application is based upon and claims the benefit of priority from Japanese Patent Application No. 2009-212188, filed Sep. 14, 2009; the entire contents of which are incorporated herein by reference.

### FIELD

Embodiments described herein relate generally to a data storage apparatus for accumulating data by a RAID control method, and a data writing/reading method for use in the apparatus.

### BACKGROUND

In recent years, as data storage apparatuses are desired to have a large capacity and high reliability, Redundant Arrays of Independent Disks (RAID) technology has frequently been adopted in the data storage apparatuses. Even when one of a plurality of memory units comprised in the data storage apparatus fails, the RAID technology can prevent loss of data accumulated in the data storage apparatus.

When a data storage apparatus comprises four memory units and adopts RAID 5, a RAID controller of the data storage apparatus divides obtained data stream into a predetermined number of data blocks and generates a block of parity data. The data blocks and the parity data block are set to have a writable unit of the memory units. The RAID controller distributes to the for memory units. The RAID controller causes each of the four memory units to store The data blocks and the parity data block, respectively. Accordingly, even if one of the four memory units fails, lost data block can be corrected based on remaining data blocks stored in the remaining three memory units. Thus, the correct data stream can be output from the data storage apparatus.

In recent years, a semiconductor memory, such as a flush memory, has been frequently used as a memory unit of a data storage apparatus because the semiconductor memory comprises no moving part and has high reliability. This type of memory unit comprises a plurality of memory chips each including a semiconductor memory, and stores data in the memory chips.

However, in a memory unit comprising a plurality of memory chips, a memory chip may be damaged due to, for example, writing operations performed to excess. If data is read from such a damaged memory chip, wrong data is reproduced, and a reproduced image is distorted. Since data restoration using the RAID technology is performed on each memory unit, data read from the damaged memory chip cannot be restored.

A method for correcting a bit error by adding a bit error correction code, such as an error correction code (ECC), to data input into a memory unit has been proposed (see, Jpn. Pat. Appln. KOKAI Publication No. 2006-323434, for example). However, the method cannot deal with the case where a memory chip is damaged.

### BRIEF DESCRIPTION OF THE DRAWINGS

FIG. 1 is a block diagram showing a functional configuration of a data storage apparatus according to an embodiment.

FIG. 2 shows writing processing performed on data blocks or parity data block in the data storage apparatus of FIG. 1.

FIG. 3 is a schematic diagram of data stored in the memories of FIG. 1.

FIG. 4 is a flowchart showing steps following which the RAID controller of FIG. 1 restores data.

### DETAILED DESCRIPTION

In general, according to one embodiment, a data storage apparatus includes a RAID controller, error detectors, and memory units. The RAID controller receives an encoded data stream, divides the encoded data stream into a predetermined number of data blocks which are set within a writable page unit, respectively, and generates a block of parity data which is utilized for correcting an error produced in one of the data blocks based on the remaining data blocks, the parity data block being set within the writable page unit. The data blocks and the parity data block are distributed to the error detectors from the RAID controller, respectively. The error detectors add an error detection code to the data blocks and the parity data block, respectively, which are utilized for checking errors in the data blocks, respectively. The memory units receive the data blocks and the parity data block from the error detectors and set the data blocks and the parity data block to have the writable page units, respectively. Each of the memory units includes a plurality of memory chips and a memory controller configured to control the memory chips. The memory controllers write the data blocks and the parity data block of the writable page units in the memory chips.

### First Embodiment

Referring the drawings, an embodiment of a data storage apparatus will be described.

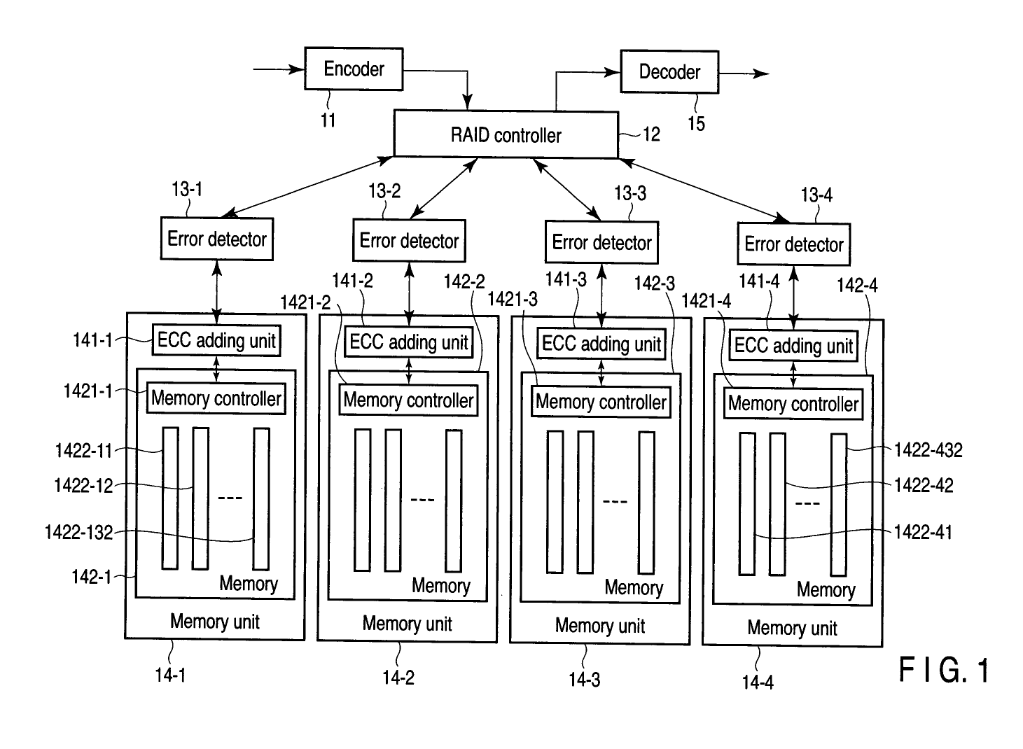

FIG. 1 is a block diagram showing a functional configuration of the data storage apparatus according to the embodiment. The data storage apparatus in FIG. 1 comprises an encoder 11, a Redundant Arrays of Independent Disks (RAID) controller 12, error detectors 13-1 to 13-4, memory units 14-1 to 14-4, and a decoder 15. The data storage apparatus has a configuration according to RAID 5.

The encoder 11 and decoder 15 are connected to the RAID controller 12. The RAID controller 12 is connected to the error detectors 13-1 to 13-4, and the error detectors 13-1 to 13-4 are connected to the memory units 14-1 to 14-4, respectively.

The encoder 11 acquires an image data stream from, for example, a camera, and encodes the image data stream by a predetermined encoding method. The encoder 11 outputs an encoded data stream to the RAID controller 12.

When data is stored, the RAID controller 12 divides the encoded data stream into three data blocks which are set within a writable page unit. The RAID controller 12 generates a block of parity data which is set within the writable page. The capacity of the writable page unit is predetermined for memory chips comprised in memories 142-1 to 142-4. The parity data block is generated in such a manner that the data blocks and parity data block together have no “1” or even-numbered “1.” The RAID controller 12 distributes three data blocks to three of the error detectors 13-1 to 13-4, and outputs the parity data block to the remaining one of the error detectors 13-1 to 13-4. The RAID controller 12 sequentially switches the error detector to which parity data block is output, allowing the other error detectors receive the data blocks.

When data is reproduced, the RAID controller 12 receives the data blocks and the parity data block from the error detectors 13-1 to 13-4. When an error occurs in one of the data blocks, the RAID controller 12 restores the data block including the error based on the remaining data blocks and the parity data block. The RAID controller 12 synthesizes the restored data block and remaining data blocks to generate the encoded data stream. On the other hand, if no error occurs, the RAID controller 12 synthesizes the data blocks from the three of error detectors 13-1 to 13-4 to generate the encoded data stream. The RAID controller 12 outputs the encoded data stream to the decoder 15.

The decoder 15 decodes the encoded data stream from the RAID controller 12 by a decoding method according to the encoding method of the encoder 11 to generate the image data stream. The decoder 15 outputs the image data stream to the outside.

When data is recorded, the error detectors 13-1 to 13-4 add an error detection code, such as a checksum, to the data blocks and the parity data block from the RAID controller 12, respectively. The error detectors 13-1 to 13-4 output the data blocks and the parity data block to which error detection codes are added to the memory units 14-1 to 14-4, respectively.

When data is reproduced, the error detectors 13-1 to 13-4 receive the data blocks and the parity data block from the memory units 14-1 to 14-4, respectively. The error detectors 13-1 to 13-4 determine whether the data blocks and the parity data block from the memory units 14-1 to 14-4 include an error based on the error detection codes. Upon detection of the error in the data blocks and the parity data block, the error detectors 13-1 to 13-4 generate a detection signal to output the detection signal to the RAID controller 12.

The memory units 14-1 to 14-4 have ECC adding units 141-1 to 141-4 and memories 142-1 to 142-4. The memories 142-1 to 142-4 comprise memory controllers 1421-1 to 1421-4, and memory chips 1422-11 to 1422-132, . . . , 1422-41 to 1422-432, each of which includes a semiconductor memory such as a flush memory.

When data is recorded, the memory units 14-1 to 14-4 store the data blocks and the parity data block from the error detectors 13-1 to 13-4. The same processing is performed in the memory units 14-1 to 14-4, and the processing in memory unit 14-1 will be representatively described.

The ECC adding unit 141-1 adds an ECC, which is an error correction code, to the data block of the parity data block from the error detector 13-1. The data block or the parity data block to which the ECC has been added is output to the memory 142-1.

In the memory 142-1, upon receipt of the data block or the parity data block from the ECC adding unit 141-1, the memory controller 1421-1 divides the data block or the parity data block, and writes the divided data in the memory chips 1422-11 to 1422-132 in parallel.

When data is reproduced, the memory units 14-1 to 14-4 read the recorded data blocks and the recorded parity data block, and output them to the error detectors 13-1 to 13-4, respectively. The same processing is performed in the memory units 14-1 to 14-4, and the processing in memory unit 14-1 will be representatively described.

The memory controller 1421-1 reads the data block or the parity data block stored in the memory chips 1422-11 to 1422-132, and outputs the data to the ECC adding unit 141-1.

The ECC adding unit 141-1 corrects a error in the data block or the parity data block from the memory 142-1 based on the ECC. The ECC adding unit 141-1 outputs the data block or the parity data block of which the error has been corrected to the error detector 13-1.

Next, operations of the data storage apparatus with the above configuration will be described.

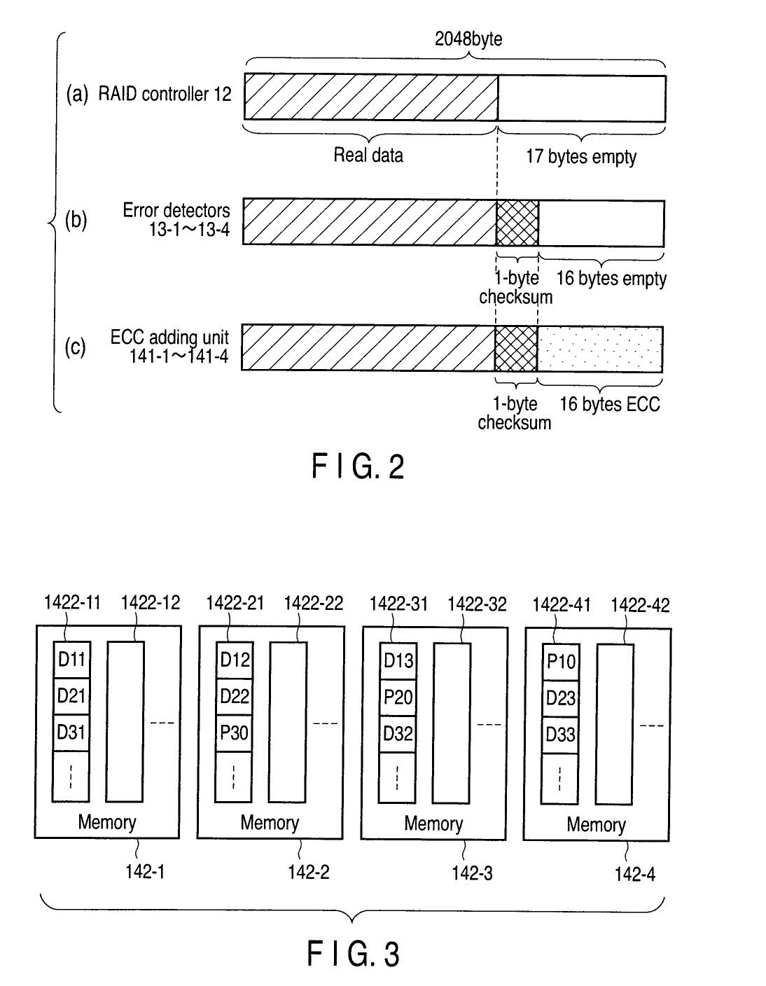

FIG. 2 is a schematic diagram showing recording processing performed on the data block or the parity data block in the data storage apparatus according to the embodiment. In the present embodiment, the capacity of one writable page is 2048 bytes, but the capacity of one writable page is not limited to this number.

When data is recorded, the RAID controller 12 divides the encoded data stream from the encoder 11 into data blocks comprised of 2031 bytes as shown in FIG. 2 (a). The data block includes real data of 2031 bytes. The capacity of the real data is 17 bytes fewer than that of one writable page, i.e., 2048 bytes. The RAID controller 12 outputs the three data blocks shown in FIG. 2 (a) to three error detectors of the error detectors 13-1 to 13-4.

The RAID controller 12 generates a block of parity data of 2031 bytes as shown in FIG. 2 (a) based on the data blocks. The parity data block includes real data. The capacity of the real data is 17 bytes fewer than 2048 bytes, which is the capacity of one writable page. The RAID controller 12 outputs the parity data block shown in FIG. 2 (a) to one error detector of the error detectors 13-1 to 13-4.

When data is reproduced, the RAID controller 12 receives the data blocks shown in FIG. 2 (a) from three error detectors of the error detectors 13-1 to 13-4. The RAID controller 12 also receives the parity data block shown in FIG. 2 (a) from one error detector of the error detectors 13-1 to 13-4.

When the RAID controller 12 receives the detection signal from one of the error detectors 13-1 to 13-4, the RAID controller 12 determines that an error occurs in the data blocks or the parity data block supplied from the error detector generating the detection signal. If the RAID controller 12 determines that one of the data blocks includes the error, the RAID controller 12 restores the data block including the error based on the remaining data blocks and the parity data block. The RAID controller 12 synthesizes the restored data block and the remaining data blocks to generate the encoded data stream. If the RAID controller 12 determines that no data block includes the error, the RAID controller 12 synthesizes the data blocks from three of the error detectors 13-1 to 13-4 to generate the encoded data stream. The RAID controller 12 outputs the encoded data stream to the decoder 15.

When data is recorded, the error detectors 13-1 to 13-4 add a checksum of one byte to the data blocks and the parity data block from the RAID controller 12 as shown in FIG. 2 (b), respectively. The error detectors 13-1 to 13-4 output the data blocks and the parity data block shown in FIG. 2 (b) to the memory units 14-1 to 14-4, respectively.

When data is reproduced, the error detectors 13-1 to 13-4 receive data blocks and parity data block shown in FIG. (b) from the memory units 14-1 to 14-4, respectively. The error detectors 13-1 to 13-4 refer to the checksums, and determine whether or not an error has occurred in the data blocks and the parity data block. If the error detectors 13-1 to 13-4 determine that the error occurs in the data blocks and the parity data block, the error detectors 13-1 to 13-4 generate the detection signal to output the detection signal to the RAID controller 12. For example, if the error detector 13-1 determines that the error occurs in the received data block or the received parity data block, the error detector 13-1 generates the detection signal to output the detection signal to the RAID controller 12. The error detectors 13-1 to 13-4 output the data blocks and the parity data block shown in FIG. 2 (a) to the RAID controller 12.

When data is recorded, the ECC adding units 141-1 to 141-4 add an ECC of 16 bytes to the data blocks and the parity data block from the error detectors 13-1 to 13-4 after the checksums, respectively, as shown in FIG. 2 (c). The ECC adding units 141-1 to 141-4 output the data blocks and the parity data block shown in FIG. 2 (c) to the memories 142-1 to 142-4. Accordingly, the capacity of 2048 bytes is fully occupied. The data blocks and the parity data block to which ECCs have been added are written in the memory chips 1422-11 to 1422-132, . . . , 1422-41 to 1422-432 by the memory controllers 1421-1 to 1421-4.

When data is reproduced, the ECC adding units 141-1 to 141-4 receive the data blocks and the parity data block shown in FIG. 2 (c) from the memories 142-1 to 142-4. The ECC adding units 141-1 to 141-4 correct an error in the data blocks and the parity data block using the ECCs. The ECC adding units 141-1 to 141-4 output the data blocks and the parity data block shown in FIG. 2 (b) to the error detectors 13-1 to 13-4.

FIG. 3 shows a schematic diagram of the data blocks and the parity data block stored in the memories 142-1 to 142-4 by the above-described processing. In FIG. 3, D11, D12, D13, . . . represent the data block, and P10, 20, P30, . . . represent the parity data block. The data blocks and the parity data block are written in units of one writable page, which are write units of the memory chips. The memory unit in which the parity data block is stored is switched by the RAID controller 12 every writable page unit.

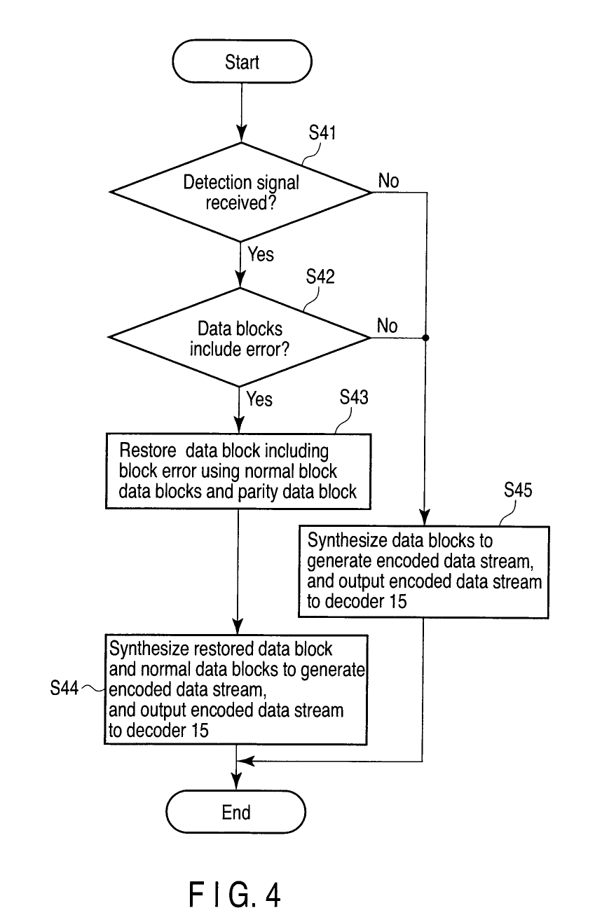

FIG. 4 is a flow chart following which the RRID controller 12 restores the data block including the error in the data storage apparatus according to the present embodiment.

The RAID controller 12 determines whether a detection signal is transmitted from any error detector of the error detectors 13-1 to 13-4 (step S41). When it is determined that the detection signal is transmitted (Yes in step S41), the RAID controller 12 determines that the data block or the parity data block from the error detector from which the detection signal is transmitted includes a error. The RAID controller 12 determines whether or not the data block includes the error (step S42). When the data block includes the error (Yes in step S42), the RAID controller 12 restores the data block including the error based on the normal two data blocks and the parity data block (step S43). The RAID controller 12 synthesizes restored data block and the normal two data blocks to generate the encoded data stream, and output the encoded data stream to the decoder 15 (step S44).

When the detection signal is not received in step S41 (No in step S41), the RAID controller 12 synthesizes three data blocks to generate the encoded data stream, and output the encoded data stream to the decoder 15 (step S45).

When it is determined no data block includes the error in step S42 (No in step S42), the RAID controller 12 moves the processing to step S45.

In the above-described embodiment, the RAID controller 12 outputs the data blocks and the parity data block of which the capacity are within the writable page to the error detectors 13-1 to 13-4, respectively. The error detectors 13-1 to 13-4 add an error detection code to the data blocks and the parity data block from the RAID controller 12. If the error detectors 13-1 to 13-4 receive the data blocks and the parity data block from the memory units 14-1 to 14-4, respectively, error detection is performed on each page based on the error detection codes added to the data. Accordingly, a failure of a memory chip can be detected in units of one writable page, i.e., in writable units of the memory chips.

In the above-embodiment, if an error detector of the error detectors 13-1 to 13-4 detects an error in the received data blocks, the RAID controller 12 restores the data block including the error based on the normal data blocks and the parity data block. Accordingly, when a memory chip fails, the data block stored in that memory chip can be restored.

In a conventional device using RAID 5, if two or more memory units fail, data cannot be restored. Therefore, a memory unit which has failed to read data is treated as a failed memory unit, and needs to be replaced. In the data storage apparatus according to the present embodiment, a failure is determined and data is restored for each writable unit of the memory chips. Therefore, even when a memory chip fails, the entire memory unit does not fail, and the memory unit including a failed memory chip may be continuously used. Further, since presence or absence of a failure is determined for each memory chip, only the failed memory chip may be replaced.

The data storage apparatus and data writing/reading method according to the present embodiment enables restoration of data even when a memory chip fails. Consequently, a data storage apparatus of higher reliability can be realized.

The data storage apparatus is not limited to the above embodiment. For example, the data storage apparatus according to the above embodiment adopts RAID 5, but the RAID level is not limited to RAID 5, and the data storage apparatus may adopt any RAID method in which parity data is generated, such as RAID 3 or RAID 4.

In the above embodiment, the image data stream is encoded by the encoder 11, and the encoded data stream is output to the RAID controller 12. However, the encoded data stream may be externally received, and the encoded data stream may be output to the RAID controller 12.

In the above embodiment, the error detectors 13-1 to 13-4 add a checksum. However, the error detection code is not limited to the checksum, and may be, for example, a CRC.

In the above embodiment, the data storage apparatus comprises the ECC adding units 141-1 to 141-4. However, the data storage apparatus may not comprise the ECC adding units 141-1 to 141-4.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage apparatus comprising:
a RAID controller configured to receive an encoded data stream, divide the encoded data stream into a predetermined number of data blocks which are set within a writable page unit, respectively, and generate a block of parity data which is utilized for correcting a error produced in one of the data blocks based on the remaining data blocks, the parity data block being set within the writable page unit;
error detectors to which the data blocks and the parity data block are distributed from the RAID controller, respectively, wherein the error detectors are configured to add an error detection code to the data blocks and the parity data block, respectively, which are utilized for checking errors in the data blocks, respectively;
memory units configured to receive the data blocks and the parity data block from the error detectors and set the data blocks and the parity data block to have the writable page units, respectively, wherein each of the memory units includes a plurality of memory chips and a memory controller configured to control the memory chips, and the memory controllers write the data blocks and the parity data block of the writable page units in the memory chips.

2. The data storage apparatus of claim 1, wherein
the memory units store the data blocks and the parity data block in the memory chips, wherein the memory controllers read the respective data blocks and the parity data block from the memory chips, respectively,
the error detectors receive the data blocks and the parity data block from the memory units, respectively, wherein each of the error detectors generates an error detection signal, if the error detector detects an error, based on the error detection code, in the received data block or the received parity data block,
the RAID controller corrects the error produced in one of the data blocks based on the remaining data blocks and the parity data block in response to the detection signal, synthesizes the corrected data block and the remaining data blocks to generate the encoded data stream, and outputs the encoded data stream.

3. The data storage apparatus of claim 1, wherein the memory units further include error correction units which add an error correction code to the data blocks and the parity data block from the error detectors, respectively, the error correction code being utilized for correcting an error included in the data blocks and the parity data block.

4. The data storage apparatus of claim 2, wherein the memory units further include error correction units which add an error correction code to the data blocks and the parity data block from the error detectors, respectively, and correct an error included in the data blocks and the parity data block read from the memory chips based on the error correction code.

5. A data storage apparatus comprising:
memory units each of which includes a plurality of memory chips and a memory controller configured to control the memory chips, and which store data blocks of writable page units and a parity data block of the writable page unit in the memory chips, respectively, wherein each of the data blocks and the parity data block includes a error detection code, and the memory controllers read the respective data blocks and the parity data block from the memory chips, respectively;
error detectors configured to receive the data blocks and the parity data block from the memory units, respectively, wherein each of the error detectors generates a error detection signal, if the error detector detects an error, based on the error detection code, in the received data block or the received parity data block;
a RAID controller configured to correct the error produced in one of the data blocks based on the remaining data blocks and the parity data block in response to the detection signal, synthesize the corrected data block and the remaining data blocks to generate an encoded data stream, and output the encoded data stream.

6. The data storage apparatus of claim 5, wherein
each of the data blocks and the parity data block further includes an error correction code, and
the memory units further include error correction units which correct an error included in the data blocks and the parity data block read from the memory chips based on the error correction code.

7. A method for writing/reading data for use in a data storage apparatus comprising:
receiving an encoded data stream by a RAID controller;
dividing the encoded data stream into a predetermined number of data blocks which are set within a writable page unit, respectively, by the RAID controller;
generating a block of parity data which is utilized for correcting an error produced in one of the data blocks based on the remaining data blocks by the RAID controller, the parity data block being set within the writable page unit;
distributing the data blocks and the parity data block to error detectors, respectively, by the RAID controller;
adding an error detection code to the data blocks and the parity data block, respectively, by the error detectors, the error detection code being utilized for checking errors in the data blocks, respectively;
setting the data blocks and the parity data block received from the error detectors to have the writable page units, respectively, by memory units, wherein each of the memory units includes a plurality of memory chips and a memory controller configured to control the memory chips;
writing the data blocks and the parity data block of the writable page units in the memory chips by the memory controllers.

8. The method for writing/reading data of claim 7, comprising:
reading the respective data blocks and the parity data block stored in the memory chips, respectively, by the memory controllers;
outputting the data blocks and the parity data block read from the memory chips to the error detectors, respectively, by the memory units;
generating a error detection signal, if the error detectors detect an error, based on the error detection code, in the received data block or the received parity data block from the memory units by the error detectors;
correcting the error produced in one of the data blocks based on the remaining data blocks and the parity data block in response to the detection signal by the RAID controller;
synthesizing the corrected data block and the remaining data blocks to generate the encoded data stream by the RAID controller.
